(19) United States
(12) Patent Application Publication
(10) Pub. No.: US 2005/0201372 A1
(43) Pub. Date: Sep. 15, 2005

(54) Systems and methods for virtual broadcast subnetworks

(76) Inventor: Susan Hares, Saline, MI (US)

Correspondence Address: PERKINS COIE LLP, P.O. BOX 2168, MENLO PARK, CA, 94026, US

(21) Appl. No.: 11/056,925

(22) Filed: Feb. 11, 2005

Related U.S. Application Data
(60) Provisional application No. 60/544,100, filed on Feb. 11, 2004.

(51) Int. Cl. H04L 12/28

(52) U.S. Cl. 370/389; 370/466

(57) ABSTRACT

Extensions to the ES-IS protocol are described which include virtual nodes and virtual sub-network identifiers. Techniques for selecting a physical IS forwarder amongst multiple candidates in a virtual node may include tie-breaking mechanisms based on pre-emption values supported by the ES-IS extensions Embodiments allow integration between ES-IS based broadcast networks supporting the Internet Protocol (IP) and the Virtual Router Redundancy Protocol (VRRP). In some embodiments, this integration is accomplished in part by translating packet data units between ES-IS and versions of VRRP. In some such embodiments, nodes on an internetwork maintain concurrent state tables for ES-IS and VRRP.

### CLAIM OF PRIORITY

This application claims priority to U.S. Provisional Application No. 60/544,100, entitled VIRTUAL BROADCAST SUBNETWORKS, filed Feb. 11, 2004, which is hereby incorporated by reference in its entirety.

### FIELD OF THE INVENTION

This Invention is related to the field of networking, and more specifically, to broadcasting, discovery, and virtualization techniques in packet-switched networks.

### BACKGROUND

The prior art includes legacy protocols for broadcasting, discovery, and virtualization on a packet-switched network. One such example is ES-IS, an OSI protocol that allows communication between terminals or hosts on a network (referred to in the protocol as “End Systems,” or “ESs”) and routers within the network or coupling networks (referred to in the protocol as Intermediate Systems (ISs)). ES-IS is specified by the OSI standard 9542. ES-IS acts as a discovery protocol similar to the Internet's ARP (Address Resolution Protocol), and allows End Systems to take part in internetwork routing.

During the discovery process, the ESs and ISs locate one another. At regular intervals, ESs generate ES Hello messages (ESHs) and send them to routers on the network. Likewise, ISs generate IS Hello messages (ISHs) and send them to hosts on their attached subnetworks. The messages transmit OSI network layer and OSI subnetwork addresses.

Legacy protocols such as ES-IS and IS-IS include techniques for supporting virtual broadcast subnetworks, which were supported later in the IP protocol through techniques such as the Virtual Router Redundancy Protocol, or VRRP. There is a need to extend legacy protocols, such as ES-IS, as well as to allow translation of these legacy protocols into similar IP protocols. These and other objects of the invention are described further herein.

### SUMMARY OF THE INVENTION

This invention extends the ES-IS protocol to include virtual nodes and virtual sub-network identifiers. In some such embodiments, multiple ISs may share a single address, thereby comprising a virtual node. Such embodiments include techniques for selecting a physical IS forwarder amongst multiple candidates in a virtual node. Some such embodiments include tie-breaking mechanisms for selecting physical IS forwarders amongst several candidates for a virtual node. Some such embodiments associate pre-emption values with the physical forwarders to facilitate such tie-breaking.

Embodiments of the invention also allow integration between ES-IS based broadcast networks supporting the Internet Protocol, or IP, with the Virtual Router Redundancy Protocol, or VRRP. In some embodiments, this integration is accomplished in part by translating packet data units between ES-IS and versions of VRRP. In some such embodiments, nodes on an internetwork maintain concurrent state tables for ES-IS and VRRP. These and other embodiments of the invention are described in further detail herein.

### BRIEF DESCRIPTION OF THE FIGURES

FIG. 1 illustrates a format for source addresses for extensions to ES-IS in accordance with embodiments of the invention.

FIG. 2 illustrates formats for Pseudo-LAN identifiers, Virtual Intermediate System identifiers, and extended connection timers in accordance with embodiments of the invention.

FIG. 3 illustrates a state table for an extended ES-IS protocol in accordance with embodiments of the invention.

FIG. 4 illustrates PDU translations between ES-IS and versions of VRRP in accordance with embodiments of the invention.

FIG. 5 illustrates interaction between ES-IS and VRRP state machines in accordance with embodiments of the invention.

FIG. 6 illustrates a comparison between ES-IS and VRRP timers in accordance with embodiments of the invention.

### DETAILED DESCRIPTION

This invention extends the ES-IS protocol to include virtual nodes (ES and IS) and virtual sub-network identifiers. In some such embodiments, multiple ISs may share a single address, thereby comprising a virtual node. Such embodiments include techniques for selecting a physical IS forwarder amongst multiple candidates in a virtual node. In some embodiments of the invention, ES-IS is extended with an election sequence which includes a pre-emption value. In some such embodiments, the election sequence elects a physical IS (also referred to as a “forwarder”) amongst several associated with a Virtual IS. Some such election sequences may include a tie-breaking mechanism such as the following:
a comparison of a “pre-empt” value. (A non-existent pre-empt value indicates the lowest value.)
Comparison of MAC addresses passed in the SNPA option (A non-existent SNPA value is the lowest), or
a NET address of the sending node. (in an IP node the NET includes the IP address inside the NET).

Other election sequences and tie-breaking mechanisms employing a pre-empt value shall be apparent to those skilled in the art.

To support many virtual local area networks (VLANs) on the broadcast sub-network, embodiments at the invention include two identifiers: a virtual broadcast-sub-network identifier and a pseudo-node identifier. A single IS may participate in several virtual broadcast sub-networks (Virtual broadcast sub-networks are also denoted in literature as virtual local area networks or VLANs). An IS may be also represented as a virtual IS comprised of several physical IS on a single virtual LAN. A virtual IS identifier denotes the virtual IS a physical node is associated with. Addresses may be associated with any particular virtual-IS.

Extensions to ES-IS Packets

Embodiments of the invention allow the ISH packets to include new options including but not limited to: a Source Address option, Pseudo-Node identifier option, Virtual-IS identifier option, an Extended Connection Timer option, and an extended SNPA option.

In embodiments of the invention the pseudo-node identifier can be passed in the IS and the ES packet in a “reserved” byte (byte 4) or as an option in the packet. In some embodiments, if an implementation does not set the pseudo-node identifier in byte 4, the byte may be set to a value of “0xFF”. Other bytes in which the pseudo-node identifier may be included shall be apparent to those skilled in the art.

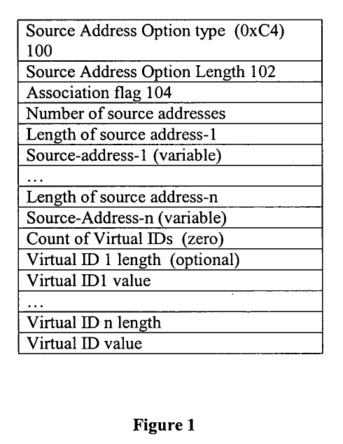

FIG. 1 illustrates, by way of non-limiting example, a format for the Source Address Option 100, including an option length field 102.

In embodiments of the invention, an association flag 104 may have two states:
0=All Virtual IDs (see table 3) are associated with these addresses
1=List of Virtual IDs below are associated with these addresses

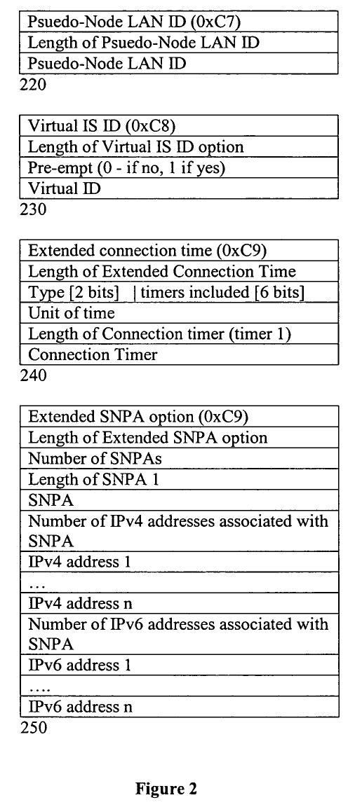

FIG. 2 illustrates example formats for the pseudo-node option 220, virtual-IS identifier option 230, an extended Connection Timer option 240, and an extended SNPA option 250. The Connection Timer option 240 includes a type field 242, which may designate one of two bits Type=two bits: E I
E=End-system Configuration timer
I=Intermediate-system Configuration timer

The Connection Timer option 240 may also include Timer flags, which as a non-limiting example may have 6 bits for 6 types of timers, with “0x01” indicating a configuration timer. As a non-limiting example, a configuration timer default may be set at 1 second. A hold timer default is 3 multiplied by the configuration timer for virtual LANs.

The Extended SNPA option 250 allows flexible matching of Sub-network points of attachments with the IP addresses in a virtual router.

Integration of ES-IS Extensions with IP

To provide integration with IP embodiments of this invention support interaction between ES-IS and existing link-layer protocols such as: ARP (host, gratuitous ARP, Proxy ARP), and Redirects. Embodiments also support integration with IPv6. In some such embodiments, the invention integrates ES-IS with the Neighbor Advertisement feature of IPv6.

In embodiments of the invention, the integration of ES-IS with IP operates as follows:
For any ES-IS nodes supporting IPv4 addresses, the IS will send a gratuitous ARP containing the virtual IS SNPA information (MAC addresses) associating the IP addresses associated with the Virtual IS SNPA,
For any nodes supporting IPv6 addresses, the IS will:
   Compute and join the solicited-node multicast address for the link-local IPv6 address of the virtual IS,
   Send an unsolicited ND Neighbor Advertisement with the Router Flag (R) set, the Solicited Flag (S) unset, the Override Flag of the Virtual IS, and the Target Link Layer address set to the virtual IS MAC address.

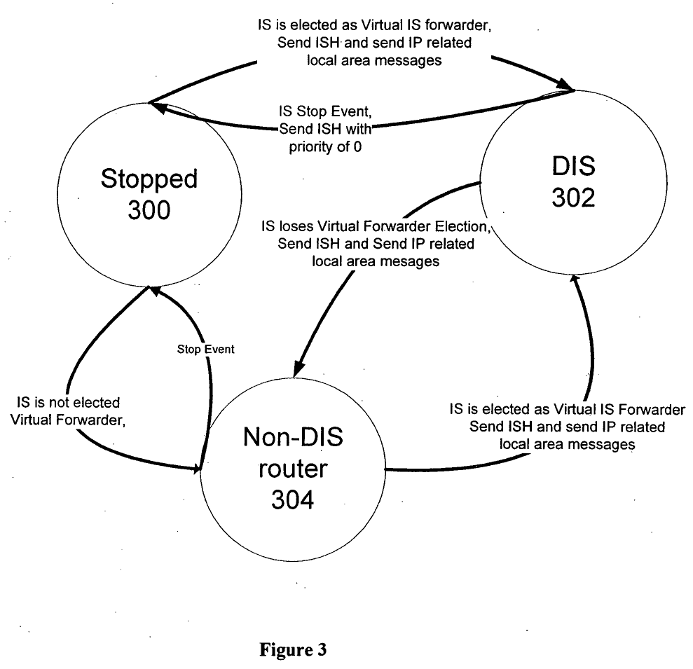

In embodiments of the invention, as illustrated in FIG. 3, the State machines for the ES-IS protocol are extended to include three states: initialization state 300, Dual IS (DIS) Forwarder 302, Non-DIS forwarder 304.

Translation Between VRRP and ES-IS

Embodiments of the invention enable interaction between ES-IS for VLANs and VRRP versions 1-3 by:
Translating VRRP packets to ES-IS ISH packets defined by the ES-IS for VLANs
A Translation of the State machine actions in VRRP to ES-IS state machine actions
Translation of timers in VRRP to ES-IS for VLAN timers

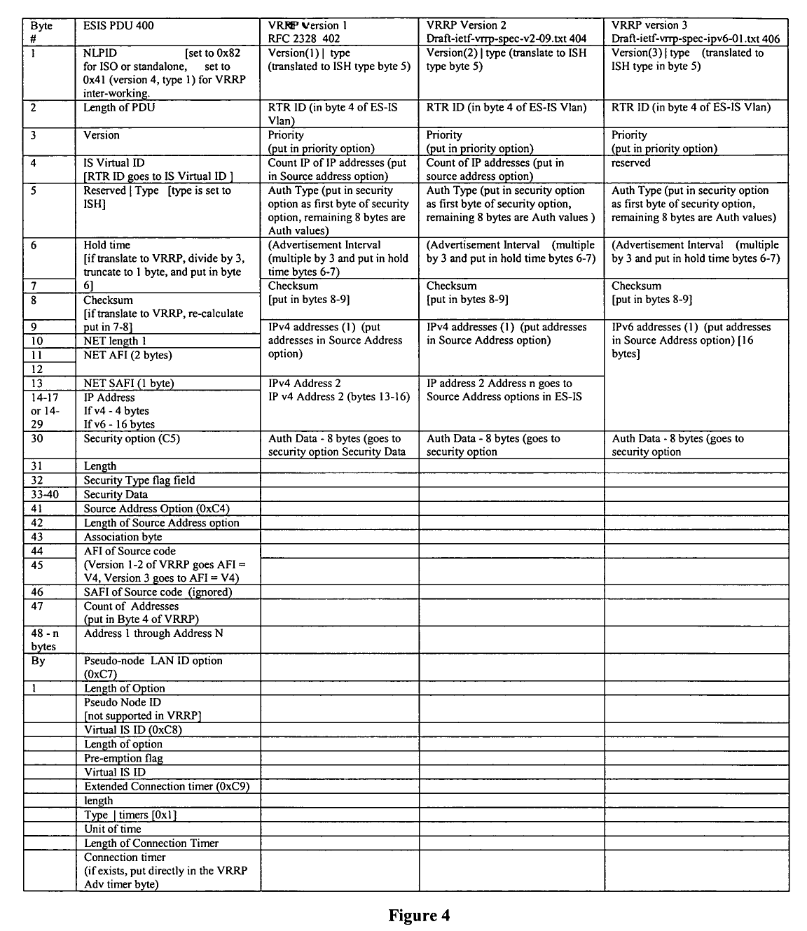

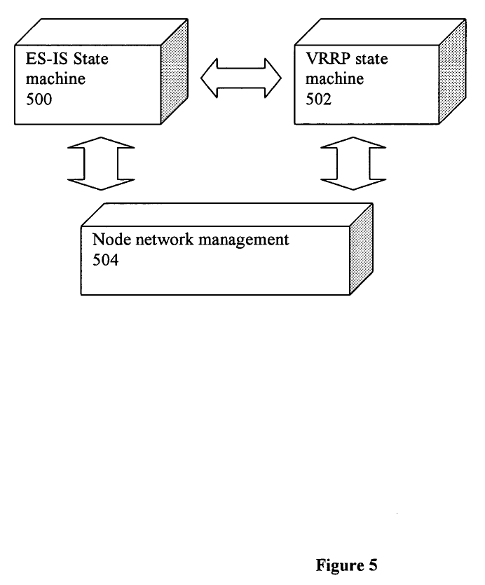

FIG. 4 illustrates, as a non-limiting, illustrative example a translation between packet data units, or PDUs for ES-IS 400, and PDUs for VRRP versions 1 through 3 402 402 406. FIG. 5 illustrates an interaction between an ES-IS state machine 500, a VRRP state machine 502, and node network management 504, in accordance with embodiments of the invention.

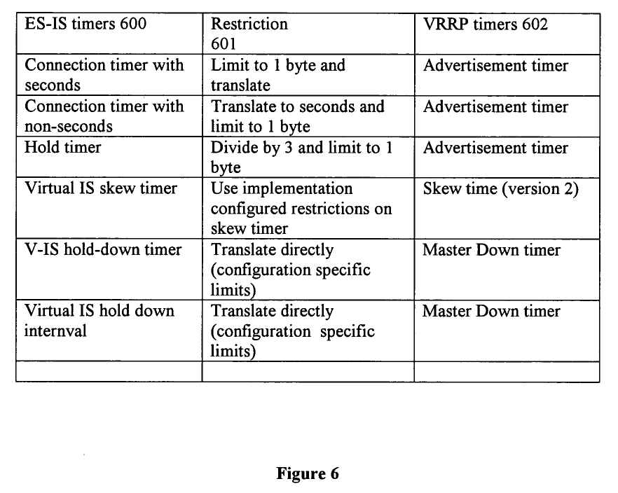

To allow interaction between ES-IS and VRRP, in embodiments of the invention the packet data units (PDUs) are translated between the protocols, and state machines for each protocol are run in parallel. As a non-limiting example, the state machines may be coordinated as follows, with reference to the timer comparisons between ES-IS timers 600 and VRRP timers 602 illustrated in FIG. 6:
Issue start-up events to both machines,
When Connection Timer expires, originate the appropriate ISH packet.
When the Adver_Timer expires, originate the appropriate VRRP packet.
If a VRRP Advertisement is received, translate it to the appropriate ISH packet, and hand it to the ESIS state machine.
If a ISH packet is received, translate it to the appropriate VRRP advertisement and hand it to the VRRP machine.
If a shut down event is signaled by the node system administration, send a shut-down event to both events.
If a master_down_timer fires, execute the VRRP transition. Flag network management with current value of Hold timer and the indication that master_down timer has fired.
If the Hold_timer expires, execute the ESIS State machine transition. Flag the network management with the current value of the master_down_timer for the same router (physical IS in ESIS/Virtual Router in VRRP).

The embodiments and examples presented herein are for illustrative purposes only. Many alternatives and equivalents shall be readily apparent to those skilled in the art.

1. In an internetwork supporting a End System to Intermediate System (ES-IS) communication protocol, a method of selecting a physical router to receive traffic from the internetwork, wherein the physical router is selected from a plurality of candidate routers, such the plurality of candidate routers is associates with a common network address, the method comprising:
assigning a pre-emption value to each of the plurality of candidate routers, wherein the pre-emption value is assigned to each of the plurality of candidate routers by operation of the ES-IS communication protocol;
receiving a query for the common network address;
comparing the pre-emption value for each of the plurality of candidate routers
in response to comparing the pre-emption value, selecting the physical router, wherein the physical router has a highest pre-emption value amongst the candidate routers.

2. The method of claim 1, further comprising:
after selecting the physical router, routing the query to the physical router via the common address.

3. The method of claim 2, wherein the internetwork communicates at least partially via Internet Protocol.

4. The method of claim 1, further comprising:
comparing a MAC address for each of the plurality of candidate routers.

5. The method of claim 1, wherein one or more of the plurality of candidate routers are contained in a second plurality of routers.

6. The method of claim 5, wherein the second plurality of routers is associated with a second common address.

7. In an internetwork supporting a End System to Intermediate System (ES-IS) communication protocol, wherein the internetwork is also in communication via an internet protocol, a method of selecting a physical router to receive traffic from the internetwork, wherein the physical router is selected from a plurality of candidate routers, such the plurality of candidate routers is associates with a common network address, the method comprising:
receiving one or more packets directed to the common network address;
in response to the receiving the one or more packets, selecting amongst the plurality of candidate routers, wherein the candidate routers are operative to select the physical router via VRRP and ES-IS.

8. The method of claim 7, further comprising:
translating a plurality of packets from the ES-IS protocol to the VRRP protocol.

9. The method of claim 8, wherein the plurality of packets includes an Intermediate Systems Hello (ISH) packet.

10. The method of claim 7, wherein one or more of the plurality of candidate routers maintains a first state table for the ES-IS protocol, and a second state table for the VRRP protocol.

11. The method of claim 9, further comprising:
simultaneously initializing the first state table and the second state table.

12. The method of claim 11, further comprising:
upon the expiration of a connection timer for the ES-IS protocol, generating the ISH packet.

13. The method of claim 12, further comprising:
upon the expiration of an advertising timer for the VRRP protocol, generating a VRRP packet.

14. The method of claim 11, further comprising:
receiving an ISH packet at a candidate router.

15. The method of claim 14, further comprising:
translating the ISH packet to a VRRP advertisement.

16. The method of claim 11, further comprising:
receiving a VRRP advertisement at a candidate router.

17. The method of claim 16, further comprising:
translating the VRRP advertisement to an ISH packet.
